(19) United States
(12) Patent Application Publication
(10) Pub. No.: US 2022/0034498 A1
(43) Pub. Date: Feb. 3, 2022

(54) Suction Cup Candle Holder

(71) Applicant: Lyle Addicks, Allen, TX (US)

(72) Inventor: Lyle Addicks, Allen, TX (US)

(21) Appl. No.: 16/947,449

(22) Filed: Aug. 2, 2020

(51) Int. Cl. F21V 35/00; F21S 13/12

(52) U.S. Cl. CPC F21V 35/00; F21S 13/12

(57) ABSTRACT

A candle holder which includes a suction cup centrally located on an axis and having opposite top and bottom sides, said bottom side having a concave shape and configured to adhere to a flat surface by a creating a vacuum when pressed against the surface, a cylindrical body extending along the axis upward from the top side of said suction cup, and a face at the end of said body located opposite the suction cup, said face lying flat in a plane perpendicular with said axis and forming a centrally located orifice for a bore that extends along the axis into said body for receiving a candle.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### STATEMENT REGARDING PRIOR DISCLOSURES BY THE INVENTOR

Not Applicable

### BACKGROUND OF THE INVENTION

### 1. Field of the Invention

The present invention is in the field of candle holders.

### 2. Background

Candles are commonly displayed on cakes for birthday and other celebratory occasions. Generally, the candles are stuck into the cake then lit. During a birthday celebration the birthday boy or girl blows out the candles, potentially contaminating the cake by projecting droplets of saliva onto it. Other party goers are then subject to exposure to any viruses or colds that might be passed through eating the contaminated cake.

Further disadvantages of displaying candles directly on a cake include the potential for the candle to drip wax onto the cake. Moreover, when removed from the cake, candles often leave undesirable holes in the icing, diminishing the cake's aesthetics.

Some attempted solutions have tried securing a candle to a cake holder by melting the bottom of the candle then contacting the melted end with the cake holder while the candle wax dries. This attempted solution has not sufficiently addressed the discussed drawbacks owing to the instability of the bond to the cake holder and the potential to melt the holder itself when the melted candle contacts the holder. Additionally, once attached the melted candles would be difficult to reposition.

Other solutions have tried utilizing a cake holder which has preset, permanent indentions in which candles can be placed. Similarly, this has not sufficiently addressed the discussed drawbacks owing to its inability to permit adjustable customization of the candle display. Furthermore, unused indentions in the cake holder interfere with viewing the cake's aesthetics.

Therefore, what is clearly needed is a candle holder that solves the problems mentioned above.

### SUMMARY OF THE INVENTION

In one embodiment of the invention a candle holder for displaying a candle on a cake cover is provided, comprising a suction cup centrally located on an axis and having opposite top and bottom sides, said bottom side having a concave shape and configured to adhere to a flat surface by a creating a vacuum when pressed against the surface, a cylindrical body extending along the axis upward from the top side of said suction cup, and a face at the end of said body located opposite the suction cup, said face lying flat in a plane perpendicular with said axis and forming a centrally located orifice for a bore that extends along the axis into said body for receiving a candle.

Also, in one embodiment the candle holder bore's walls extend vertically and run parallel to said axis. Alternatively, the bore's walls may be tapered, having a diameter at said orifice and narrowing to a smaller diameter as it enters the body.

In one embodiment of the invention the candle holder's orifice and bore are configured to receive an adaptor comprising a body on an axis, a top, and a bottom, said top having a face lying flat in a plane perpendicular with said axis and forming a centrally located orifice for a bore that extends along the axis and into said adapter's body, wherein said adapter's body is arranged for insertion into the candle holder's orifice and bore with the adapter's top extending outwardly. Also, in one embodiment said adapter's orifice and bore are adapted to receive a candle having a smaller diameter than said candle holder's orifice and bore. In another embodiment said adapter's orifice and bore are configured to receive a spike protruding from the bottom of a candle. In yet another embodiment of the invention a decorative cake topper forms a centrally located orifice configured to pass over the candle holder and rest on the exterior of the candle holder's body.

### BRIEF DESCRIPTION OF THE DRAWINGS

FIG. 1 is a perspective view of a candle holder according to an embodiment of the present invention showing its candle receiving orifice disposed uppermost.

FIG. 2 is a vertical sectional view, taken on the plane A-A, of the candle holder of FIG. 1.

FIG. 3 is a perspective view of the candle holder of FIG. 1 wherein a candle is inserted into the holder.

FIG. 4 is a vertical sectional view, taken on the plane A-A, of the candle holder of FIG. 1 wherein a candle is inserted into the holder.

FIG. 5 is a top perspective view of the candle holder of FIG. 1 wherein the candle holder is attached to a cake cover.

FIG. 6 is a side perspective view of the candle holder of FIG. 1 wherein the candle holder is attached to a cake cover.

FIG. 7 is a perspective view of a candle adapter with its candle receiving orifice disposed uppermost.

FIG. 8 is a vertical sectional view, taken on the plane B-B, of the candle adapter of FIG. 7.

FIG. 9 is a perspective view of the candle adapter of FIG. 7 inserted into the candle holder of FIG. 1.

FIG. 10 is a side view of a candle having a spiked base.

FIG. 11 is a perspective view of a second candle adapter according to another embodiment of the present invention.

FIG. 12 is a perspective view of the candle adapter of FIG. 11 inserted into the candle holder of FIG. 1.

FIG. 13 is a perspective view of a candle holder with a pull tab.

FIG. 14 is a perspective view of a double-sided adhesive pad.

FIG. 15 is a perspective view of a candle holder with a double-sided adhesive pad attached to the bottom side of the suction cup.

FIG. 16 is a perspective view of a decorative cake topper.

FIG. 17 is vertical section view, taken on the plane A-A, of the candle holder of FIG. 1 supporting the decorative cake topper of FIG. 16, taken on the plane D-D.

### DETAILED DESCRIPTION OF THE INVENTION

The inventor provides a candle holder for suction attachment to a cake cover enabling candles to be blown out with reduced likelihood of spreading viruses or colds. The present invention is described in enabling detail in the following examples, which may represent more than one embodiment of the present invention.

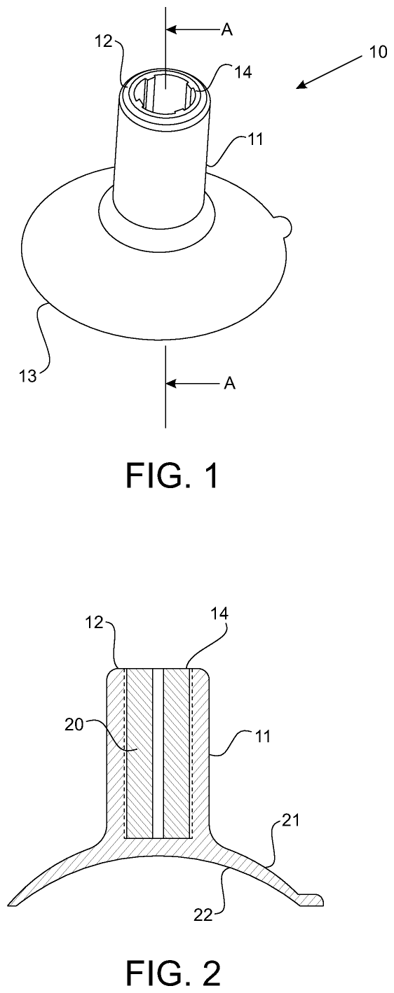

Referring to FIG. 1, the candle holder 10 comprises a body 11, a face 12, and a suction cup 13. FIG. 1 is a perspective view of a candle holder 10 according to an embodiment of the present invention showing the orifice 14 disposed uppermost. The face 12 and suction cup 13 are connected by the body 11 and molded as a one-piece structure. The candle holder 10 is symmetric about an axis, represented as A-A. At its central portion along axis A-A, the face 12 forms an orifice 14 for reception of a candle.

The face 12 is formed from one end of the body 11 opposite the suction cup 13. Moreover, the face 12 lies flat in a plane parallel to the plane on which the suction cup 13 is positioned. In other words, the face 12 lies in a plane perpendicular to the axis A-A. It is not essential that the face 12 is flat and may take on other shapes in other embodiments of the invention.

FIG. 2 is a vertical sectional view, take on the plane A-A, of the candle holder of FIG. 1. As shown in FIG. 2, a bore 20 begins at the orifice 14 and extends downward into the body 11. Like the body 11, the bore's 20 walls are vertical, circular, and run parallel to axis A-A. The bore 20 has an inner diameter fixed slightly larger than the outer diameter of a candle. In the described invention, the bore's walls are arranged to receive and support a birthday candle.

It is also possible in another embodiment of the invention for the bore 20 to have tapered walls. In this embodiment, the orifice 14 would have a first diameter and the bore's walls would narrow to a second, smaller diameter as the bore 20 enters the body 11. This embodiment would allow the candle holder 10 to be used with candles of different sized diameters. A candle with a larger diameter would intersect the bore 20 at a shallower depth than a candle with a smaller diameter. The tapered walls ensure a snug fit for either size diameter candle in this example.

In another embodiment of the invention where adaptation to different candle dimensions is needed, the bore's walls form a plurality of barbs. The barbs may be distributed and aligned horizontally in a circular pattern around the bore's walls. Alternatively, the barbs may be distributed and aligned vertically, or parallel with the A-A axis. With either configuration, the purpose of the barbs is to create resistance against the exterior of a candle inserted into the bore. In turn, the resistance aids in securing the candle inside the candle holder.

Although the orifice 14 and bore 20 in FIGS. 1 and 2 are circular in shape, any shape suitable for receipt of a candle may be used. For example, the shape of the orifice 14 and bore 20 may be triangular, square, rectangular, oval, octagonal, or pentagonal. The orifice 14 and bore 20 may be any shape which retains a candle. Although the orifice 14 is typically the same shape as the bore 20, this is not essential and the orifice 14 and bore 20 may be different shapes in other embodiments of the invention.

As shown in FIG. 2, the suction cup 13 is centered on axis A-A. Being relatively thinner than the body 11 allows the suction cup 13 to exhibit elasticity while moving between an unflexed state and a flexed state. FIG. 2 shows the suction cup 13 in its unflexed state with the bottom side 22 forming a concave shape. Having axially opposite top and bottom sides, 21 and 22, the suction cup 13 is configured to be pressed against and adhere to smooth surfaces in its flexed state. In the described embodiment of the candle holder 10, the diameter of the suction cup 13 is larger than the diameter of the face 12 to increase support of the body 11 and stability for supporting a candle.

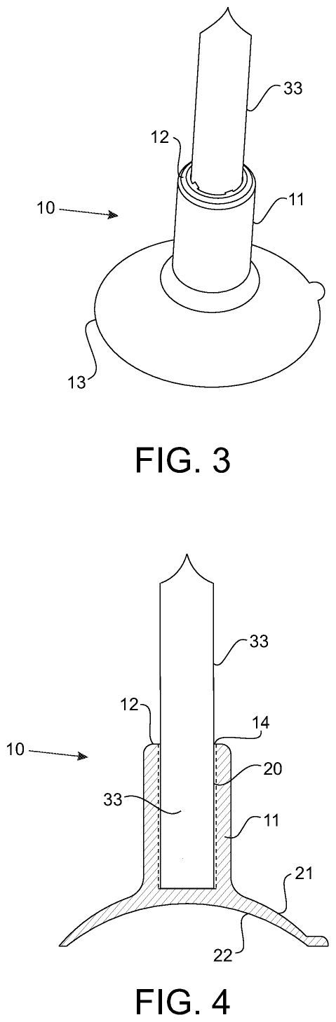

FIGS. 3 and 4 depict the candle holder 10 with a candle 33 inserted into the holder's bore 20. Once inserted, the holder's bore 20 acts to support the candle 33 in an upright position.

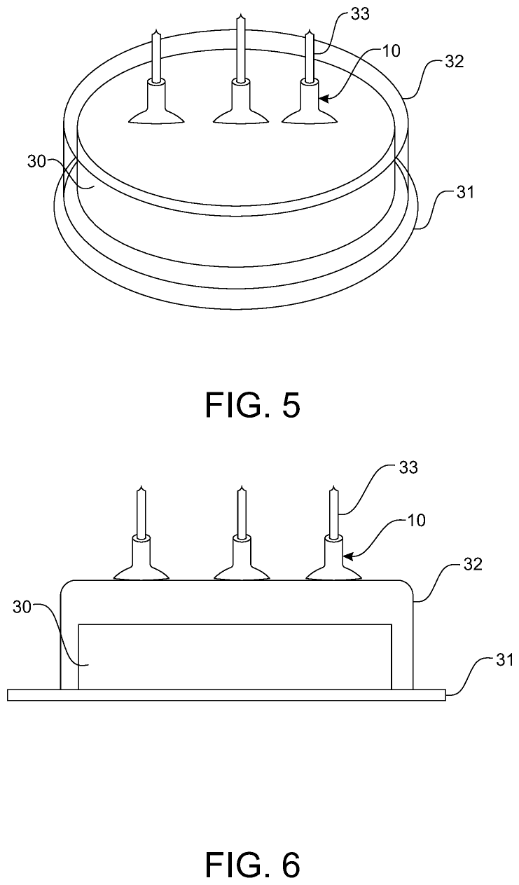

FIGS. 5 and 6 are top and side perspective views, respectively, of a cake 30 sitting on a plate 31. A cake cover 32 is positioned over the cake 30. The cover 32 is that which you would find when purchasing the cake from a grocery store or bakery or that which would find in a home kitchen. Cake covers are commonly made from plastic or glass, giving them a smooth surface.

As shown in FIGS. 5 and 6, the suction cup 13 functions to secure the candle holder 10 in place on the cover 32. As the candle holder 10 is pressed onto a cake cover 32, the air between the suction cup's bottom side 22 and the cover 32 is forced out, creating a vacuum. Although it may be advantageous to insert the candle 33 into the candle holder 10 prior to suctioning it to the cake cover 32, the candle 33 may be inserted into the candle holder 10 after suctioning it to the cake cover 32. Once the candle 33 is lit, it may be blown out without directly exposing the cake 30 to the blower's germs.

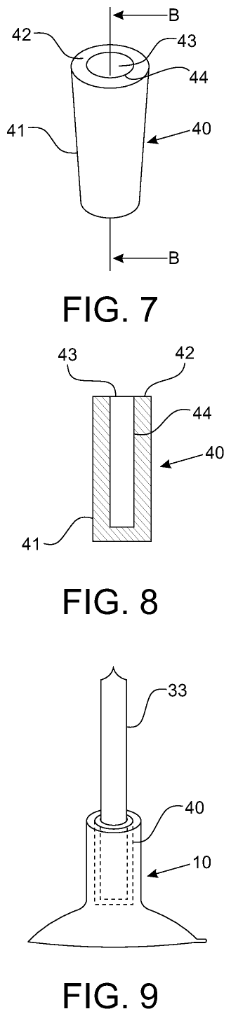

As stated, the preferred embodiment of the candle holder 10 is sized to receive, support, and display a standard, round birthday candle. The candle holder 10 is not limited to these dimensions or configuration and could be produced with an orifice 14 and bore 20 designed to fit different sizes and shapes of candles, figurines, or decorative items. Alternatively, the candle holder 10 can utilize a thin candle adapter 40 shown in FIGS. 7 through 9.

The thin candle adapter 40 comprises a body 41 and face 42. The adapter's face 42 lies flat in a plane perpendicular to the adapter's body 41. At its central portion along axis B-B, the face 42 forms an orifice 43 for reception of a candle. As shown in FIG. 8, a bore 44 begins at the adapter's orifice 43 and extends downward into the adapter's body 41. Like the adapter's body 41, the adapter bore's 44 walls are vertical, circular, and run parallel to axis B-B. The bore 44 has an inner diameter fixed slightly larger than the outer diameter of a thin candle.

Essentially, the adapter's orifice 43 and bore 44 function like the candle holder's orifice 14 and bore 20 except that they are adapted to receive a thinner candle. In turn, the adapter's body 41 is inserted into the candle holder's orifice 14 and bore 20 in the same manner a thicker candle would be. Although the preferred embodiment of the thin candle adapter 40 is configured to receive a cylindrical candle, the adapter's orifice 43 and bore 44 could be arranged and built to receive any shape of candle.

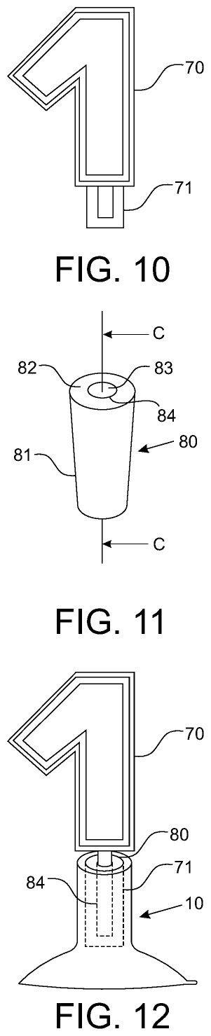

As some birthday and decorative candles have a spiked base 71, shown in FIG. 10, for insertion into a cake, yet another candle holder adapter is available for reception of a spiked candle 70 and insertion into the candle holder's orifice 14 and bore 20. FIG. 11 depicts the spiked candle adapter 80. The spike adapter 80 comprises a body 81 and a face 82. Like the thin candle adapter 40 configuration, the spike adapter's face 82 lies flat in a plane perpendicular to the spike adapter's body 81. At its central portion along axis C-C, the face 82 forms an orifice 83 for reception of a candle spike 71.

Like the thin candle adapter's 40 configuration, a bore 84 begins at the spike adapter's orifice 83 and extends downward into the adapter's body 81. Like the adapter's body 81, the adapter bore's 84 walls are vertical, circular, and run parallel to axis C-C. The bore 84 is configured to receive the spike 71 on the bottom of a spiked candle 70 as depicted in FIG. 12. Essentially, the spike adapter's orifice 83 and bore 84 function like the candle holder's orifice 14 and bore 20 except they are adapted to receive a spiked candle 70. In turn, the spike adapter's body 81 is inserted into the candle holder's orifice 14 and bore 20 in the same manner a thicker candle would be.

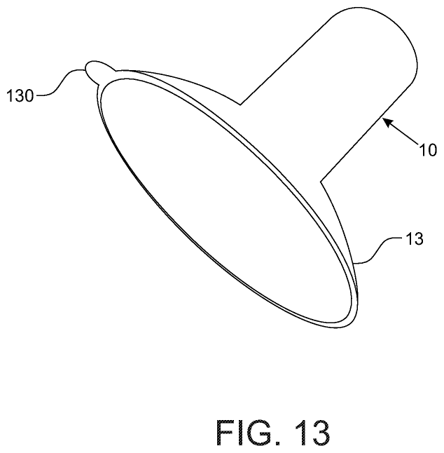

In some instances, the suction cup may create a stronger vacuum making the candle holder difficult to remove from some cake covers. As shown in FIG. 13 another embodiment of the presented invention can include a pull tab 130. The pull tab 130 extends from the outer edge of the suction cup 13 as a continuous piece of the candle holder 10 giving the user a manual release to remove the suction cup from a cake cover. To release the suction cup 13, the user would pull the tab 130 upwards away from the cake cover.

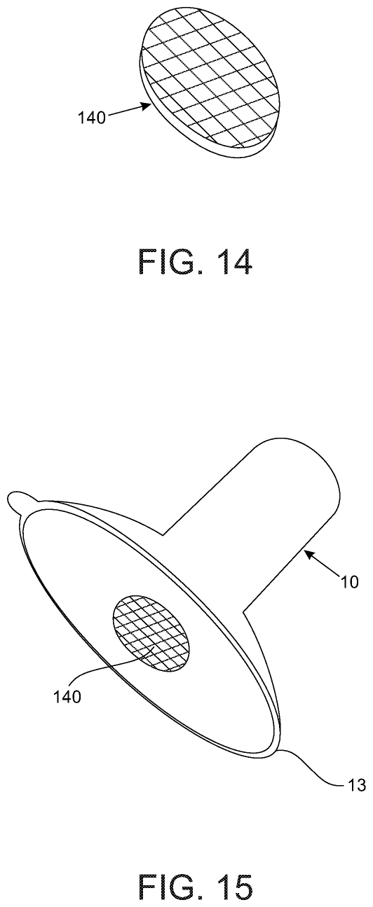

On the other hand, some surfaces are not as receptive as others to vacuum suction cup attachment. In this case double sided tape 140, shown in FIG. 14, can be attached to the suction cup's bottom 22 as show in FIG. 15. While the double-sided tape 140 would augment the candle holder's 10 ability to stick to a non-smooth surface, the tape 140 loses stickiness when removed and would have limited reusability. Additionally, in comparison with the suction cup 13 vacuum the double-sided tape 140 could be more difficult to remove from the cake holder.

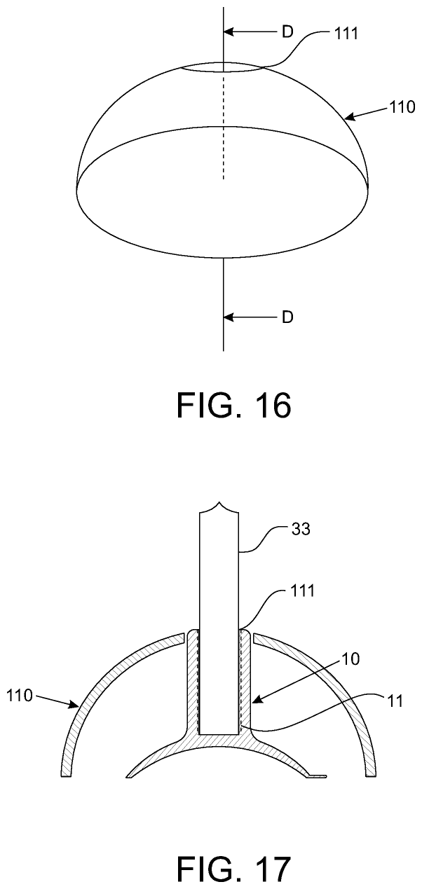

In addition to decorating cakes with candles, a variety of decorative figures are commonly used as cake toppers. Therefore, one embodiment of the current invention is adapted to incorporate a cake topper adapter 110 as shown in FIGS. 16 and 17. The topper adapter 110 can include any personal or commercial design and be shaped as a figure or character similar to commonly used cake toppers. At its central portion along axis D-D, the topper adapter 110 forms an orifice 111 for reception of the candle holder's body 11.

In use, the candle holder's body 11 is inserted, leading with the face 12, through the topper adapter's orifice 111 from the adapter's under side. The topper adapter's orifice 111 is configured and sized to fit over the face 12 and then rest against the outer surface of the body 11. Once resting against the body 11, the topper adapter 110 is displayed on a cake cover like the candle holder 10, using the candle holder's suction cup 13.

An advantage of the current embodiment of the candle holder 10, is that it can easily be removed from the cake cover 32 by pulling up on the suction cup 13. This is useful for easy rearrangement of candle holders 10 on the cake cover 32 to either create different candle formations or permit a less restricted view of the cake 30 through the cover 32. The easy removal of the suction cup 13 also enables quick cleanup after the candles have been used.

Further advantages of the current invention include its size and ease of manufacture. Because of the candle holder's size and weight, a plurality of candle holders could be displayed on a cake cover at once without weighing down or damaging the cover. Additionally, the invention's size and one-piece design permit efficient, economic manufacture by injection molding.

Finally, a single candle holder could be configured to receive, support, and display a plurality of candles.

It will be apparent to one with skill in the art that the candle holder of the invention may be provided using some or all the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the description without departing from the spirit and scope of the present invention.

What is claimed is:

1. A candle holder, comprising:
a suction cup centrally located on an axis and having opposite top and bottom sides, said bottom side having a concave shape and configured to adhere to a flat surface by a creating a vacuum when pressed against the surface;
a cylindrical body extending along the axis upward from the top side of said suction cup; and
a face at the end of said body located opposite the suction cup, said face lying flat in a plane perpendicular with said axis and forming a centrally located orifice for a bore that extends along the axis into said body for receiving a candle.

2. The candle holder of claim 1 wherein said bore's walls extend vertically and run parallel to said axis.

3. The candle holder of claim 1 wherein said bore is tapered, having a diameter at said orifice and narrowing to a smaller diameter as it enters the body.

4. The candle holder of claim 1 wherein said orifice and bore are arranged to receive an alternatively shaped birthday candle, including triangular, square, rectangular, oval, octagonal, or pentagonal shapes.

5. The candle holder of claim 1 wherein said suctions cup's diameter is larger than said face's diameter.

6. The candle holder of claim 1 wherein said suction cup further comprises a tab wherein said tab is configured to pull for release of the vacuum.

7. The candle holder of claim 1 wherein said suction cup, body, and face are made of a polymer.

8. The candle holder of claim 2 wherein said bore has a plurality of barbs extending from its walls.

9. The candle holder of claim 2 wherein said suction cup's diameter is larger than said face's diameter.

10. The candle holder of claim 8 wherein said barbs are distributed and aligned vertically in a line parallel with said axis extending through the suction cup, body, and orifice.

11. The candle holder of claim 8 wherein said barbs are aligned horizontally in a circular pattern around the bore's walls.

12. The candle holder of claim 1 wherein a double-sided adhesive attaches to the bottom of said suction cup.

13. The candle holder of claim 12 wherein said suction cup further comprises a tab wherein said tab is configured to pull for release of the vacuum.

14. A candle holder, comprising:
a suction cup centrally located on an axis and having opposite top and bottom sides, said bottom side having a concave shape and configured to adhere to a flat surface by a creating a vacuum when pressed against the surface;
a cylindrical body extending along the axis upward from the top side of said suction cup; and
a face at the end of said body located opposite the suction cup, said face lying flat in a plane perpendicular with said axis and forming a centrally located orifice for a bore that extends along the axis into said body; and
an adapter comprising a cylindrical body on an axis, a top, and a bottom, said top having a face lying flat in a plane perpendicular with said axis and forming a centrally located orifice for a bore that extends along the axis and into said adapter's body; wherein said adapter's body is arranged for insertion into the candle holder face's orifice and bore with the adapter's top extending outwardly.

15. The candle holder of claim 13 wherein said adapter's orifice and bore are adapted to receive a candle having a smaller diameter than said candle holder's orifice and bore.

16. The candle holder of claim 13 where said adapter's bore is tapered, having a diameter at the adapter's orifice and narrowing to a smaller diameter as it enters the adapter's body; wherein said adapter's orifice and bore are configured to receive a spike protruding from the bottom of a candle.

17. The candle holder of claim 13 wherein said suction cup, body, face, and adapter are made of a polymer.

18. A candle holder, comprising:
a suction cup centrally located on an axis and having opposite top and bottom sides, said bottom side having a concave shape and configured to adhere to a flat surface by a creating a vacuum when pressed against the surface;
a cylindrical body extending along the axis upward from the top side of said suction cup; and
a decorative cake topper forming a centrally located orifice configured to pass over the end of said body opposite said suction cup and said orifice further configured to rest on the exterior of said body.

19. The candle holder of claim 17 further comprising a face at the end of said body located opposite the suction cup, said face lying flat in a plane perpendicular with said axis and forming a centrally located orifice for a bore that extends along the axis into said body for receiving a candle.

20. The suction cup of claim 18 wherein said suction cup, body, and cake topper are made of a polymer.
